(19) United States
(12) Patent Application Publication
(10) Pub. No.: US 2024/0276550 A1
(43) Pub. Date: Aug. 15, 2024

(54) RANDOM ACCESS OCCASIONS FOR CONNECTED AND INITIAL ACCESS OPERATING MODES

(71) Applicant: QUALCOMM Incorporated, San Diego, CA (US)

(72) Inventors: Qian Zhang, Basking Ridge, NJ (US); Yan Zhou, San Diego, CA (US)

(21) Appl. No.: 18/166,963

(22) Filed: Feb. 9, 2023

(51) Int. Cl. H04W 74/08; H04L 5/14

(52) U.S. Cl. CPC H04W 74/0833; H04L 5/14

(57) ABSTRACT

Methods, systems, and devices for wireless communication are described. A user equipment (UE) may receive an indication of random access occasions for connected mode operation. The random access occasions may span subband full-duplex (SBFD) symbols (including uplink subbands and downlink or flexible subbands) and uplink symbols. In some cases, the random access occasions may include a first subset of random access occasions for the SBFD symbols and a second subset of random access occasions for the uplink symbols, the second subset also for initial access operation. The UE may transmit a random access message via the random access occasions based on being in a connected operating mode. If a downlink message is also scheduled via the random access occasions, the UE may use a prioritization rule to determine whether to use the set of random access occasions for downlink message reception or random access message transmission.

### FIELD OF TECHNOLOGY

The following relates to wireless communication, including the use of random access occasions for connected and initial access operating modes.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support random access occasions for connected and initial access operating modes. For example, the described techniques provide support for utilizing different sets of random access occasions for connected mode operation for a user equipment (UE). The UE may receive an indication of a set of random access occasions for the connected mode operation for the UE, and the set of random access occasions may include one or more subband full-duplex (SBFD) symbols and one or more uplink symbols. The SBFD symbols may include subbands allocated for uplink communications, downlink communications, flexible communications, or any combination thereof. In some cases, the set of random access occasions may include separate subsets of random access occasions associated with the SBFD symbols within an uplink subband or the uplink symbols. If in a connected operating mode, the UE may transmit a random access message (e.g., or perform connected mode procedures including handover, beam failure recovery (BFR)) via the set of random access occasions. In some examples, the UE may use the subset of random access occasions associated with the uplink symbols for initial access procedures while operating in an initial access operating mode.

A method for wireless communication at a UE is described. The method may include receiving a first indication of a set of random access occasions for connected mode operation for the UE, the set of random access occasions including one or more SBFD symbols and one or more uplink symbols, where a SBFD symbol includes one or more subbands allocated for uplink and one or more subbands allocated for downlink or flexible and transmitting a random access message via the set of random access occasions based on an operating mode of the UE being a connected operating mode.

An apparatus for wireless communication at a UE is described. The apparatus may include a processor, memory coupled with the processor, and instructions stored in the memory. The instructions may be executable by the processor to cause the apparatus to receive a first indication of a set of random access occasions for connected mode operation for the UE, the set of random access occasions including one or more SBFD symbols and one or more uplink symbols, where a SBFD symbol includes one or more subbands allocated for uplink and one or more subbands allocated for downlink or flexible and transmit a random access message via the set of random access occasions based on an operating mode of the UE being a connected operating mode.

Another apparatus for wireless communication at a UE is described. The apparatus may include means for receiving a first indication of a set of random access occasions for connected mode operation for the UE, the set of random access occasions including one or more SBFD symbols and one or more uplink symbols, where a SBFD symbol includes one or more subbands allocated for uplink and one or more subbands allocated for downlink or flexible and means for transmitting a random access message via the set of random access occasions based on an operating mode of the UE being a connected operating mode.

A non-transitory computer-readable medium storing code for wireless communication at a UE is described. The code may include instructions executable by a processor to receive a first indication of a set of random access occasions for connected mode operation for the UE, the set of random access occasions including one or more SBFD symbols and one or more uplink symbols, where a SBFD symbol includes one or more subbands allocated for uplink and one or more subbands allocated for downlink or flexible and transmit a random access message via the set of random access occasions based on an operating mode of the UE being a connected operating mode.

In some examples of the method, apparatuses, and non-transitory computer-readable medium described herein, the set of random access occasions includes a first subset of random access occasions associated with the one or more SBFD symbols within an uplink subband and a second subset of random access occasions associated with the one or more uplink symbols.

Some examples of the method, apparatuses, and non-transitory computer-readable medium described herein may further include operations, features, means, or instructions for receiving control information that schedules a downlink message via a periodic downlink occasion, a semi-persistent downlink occasion, or an aperiodic downlink occasion, where the scheduled downlink message at least partially overlaps the set of random access occasions and a set of corresponding gap symbols in time domain.

Some examples of the method, apparatuses, and non-transitory computer-readable medium described herein may further include operations, features, means, or instructions for prioritizing reception of the downlink message via the set of random access occasions over transmission of the random access message via the set of random access occasions based on a prioritization rule.

Some examples of the method, apparatuses, and non-transitory computer-readable medium described herein may further include operations, features, means, or instructions for prioritizing transmission of the random access message via the set of random access occasions over reception of the downlink message based on a prioritization rule.

Some examples of the method, apparatuses, and non-transitory computer-readable medium described herein may further include operations, features, means, or instructions for receiving a second indication of a second set of random access occasions for initial access operation for the UE, the second set of random access occasions including one or more uplink symbols.

In some examples of the method, apparatuses, and non-transitory computer-readable medium described herein, the second set of random access occasions for the initial access operation may be associated with an initial bandwidth part (BWP) of a primary cell (PCell) and the set of random access occasions for the connected mode operation may be associated with a first set of BWPs of the PCell or with a second set of BWPs of a second cell.

Some examples of the method, apparatuses, and non-transitory computer-readable medium described herein may further include operations, features, means, or instructions for performing an initial access procedure via the second set of random access occasions for the initial access operation based on the operating mode of the UE being an initial access operating mode.

Some examples of the method, apparatuses, and non-transitory computer-readable medium described herein may further include operations, features, means, or instructions for performing, via the set of random access occasions, a handover procedure or a BFR procedure based on the operating mode of the UE being the connected operating mode, where the random access message may be transmitted as part of the handover procedure or the BFR procedure.

Some examples of the method, apparatuses, and non-transitory computer-readable medium described herein may further include operations, features, means, or instructions for receiving a second indication of a second set of random access occasions for the connected mode operation and initial access operation for the UE, where the second set of random access occasions includes the one or more uplink symbols.

In some examples of the method, apparatuses, and non-transitory computer-readable medium described herein, a network entity supports SBFD operation and the UE supports half-duplex operation.

A method for wireless communication at a network entity is described. The method may include transmitting a first indication of a set of random access occasions for connected mode operation for a UE, the set of random access occasions including one or more SBFD symbols and one or more uplink symbols, where a SBFD symbol includes one or more subbands allocated for uplink and one or more subbands allocated for downlink or flexible and receiving a random access message via the set of random access occasions based on an operating mode of the UE being a connected operating mode.

An apparatus for wireless communication at a network entity is described. The apparatus may include a processor, memory coupled with the processor, and instructions stored in the memory. The instructions may be executable by the processor to cause the apparatus to transmit a first indication of a set of random access occasions for connected mode operation for a UE, the set of random access occasions including one or more SBFD symbols and one or more uplink symbols, where a SBFD symbol includes one or more subbands allocated for uplink and one or more subbands allocated for downlink or flexible and receive a random access message via the set of random access occasions based on an operating mode of the UE being a connected operating mode.

Another apparatus for wireless communication at a network entity is described. The apparatus may include means for transmitting a first indication of a set of random access occasions for connected mode operation for a UE, the set of random access occasions including one or more SBFD symbols and one or more uplink symbols, where a SBFD symbol includes one or more subbands allocated for uplink and one or more subbands allocated for downlink or flexible and means for receiving a random access message via the set of random access occasions based on an operating mode of the UE being a connected operating mode.

A non-transitory computer-readable medium storing code for wireless communication at a network entity is described. The code may include instructions executable by a processor to transmit a first indication of a set of random access occasions for connected mode operation for a UE, the set of random access occasions including one or more SBFD symbols and one or more uplink symbols, where a SBFD symbol includes one or more subbands allocated for uplink and one or more subbands allocated for downlink or flexible and receive a random access message via the set of random access occasions based on an operating mode of the UE being a connected operating mode.

In some examples of the method, apparatuses, and non-transitory computer-readable medium described herein, the set of random access occasions includes a first subset of random access occasions associated with the one or more SBFD symbols within an uplink subband and a second subset of random access occasions associated with the one or more uplink symbols.

Some examples of the method, apparatuses, and non-transitory computer-readable medium described herein may further include operations, features, means, or instructions for transmitting control information that schedules a downlink message via a periodic downlink occasion, a semi-persistent downlink occasion, or an aperiodic downlink occasion, where the scheduled downlink message at least partially overlaps the set of random access occasions and a set of corresponding gap symbols in time domain.

Some examples of the method, apparatuses, and non-transitory computer-readable medium described herein may further include operations, features, means, or instructions for transmitting a second indication of a second set of random access occasions for initial access operation for the UE, the second set of random access occasions including one or more uplink symbols.

In some examples of the method, apparatuses, and non-transitory computer-readable medium described herein, the second set of random access occasions for the initial access operation may be associated with an initial BWP of a PCell and the set of random access occasions for the connected mode operation may be associated with a first set of BWPs of the PCell or a second set of BWPs of a second cell.

Some examples of the method, apparatuses, and non-transitory computer-readable medium described herein may further include operations, features, means, or instructions for performing an initial access procedure via the second set of random access occasions for the initial access operation based on the operating mode of the UE being an initial access operating mode.

Some examples of the method, apparatuses, and non-transitory computer-readable medium described herein may further include operations, features, means, or instructions for performing, via the set of random access occasions for the connected mode operation, a handover procedure or a BFR procedure based on the operating mode of the UE being the connected operating mode, where the random access message may be received as part of the handover procedure or the BFR procedure.

Some examples of the method, apparatuses, and non-transitory computer-readable medium described herein may further include operations, features, means, or instructions for transmitting a second indication of a second set of random access occasions for the connected mode operation and initial access operation for the UE, where the second set of random access occasions includes the one or more uplink symbols.

In some examples of the method, apparatuses, and non-transitory computer-readable medium described herein, the network entity supports SBFD operation and the UE supports half-duplex operation.

### BRIEF DESCRIPTION OF THE DRAWINGS

FIG. 1 illustrates an example of a wireless communications system that supports using random access occasions for connected and initial access operating modes in accordance with one or more aspects of the present disclosure.

FIG. 2 illustrates an example of a wireless communications system that supports using random access occasions for connected and initial access operating modes in accordance with one or more aspects of the present disclosure.

FIG. 3 illustrates an example of a resource configuration that supports using random access occasions for connected and initial access operating modes in accordance with one or more aspects of the present disclosure.

FIG. 4 illustrates an example of a process flow that supports using random access occasions for connected and initial access operating modes in accordance with one or more aspects of the present disclosure.

FIGS. 5 and 6 illustrate block diagrams of devices that support using random access occasions for connected and initial access operating modes in accordance with one or more aspects of the present disclosure.

FIG. 7 illustrates a block diagram of a communications manager that supports using random access occasions for connected and initial access operating modes in accordance with one or more aspects of the present disclosure.

FIG. 8 illustrates a diagram of a system including a device that supports using random access occasions for connected and initial access operating modes in accordance with one or more aspects of the present disclosure.

FIGS. 9 and 10 illustrate block diagrams of devices that support using random access occasions for connected and initial access operating modes in accordance with one or more aspects of the present disclosure.

FIG. 11 illustrates a block diagram of a communications manager that supports using random access occasions for connected and initial access operating modes in accordance with one or more aspects of the present disclosure.

FIG. 12 illustrates a diagram of a system including a device that supports using random access occasions for connected and initial access operating modes in accordance with one or more aspects of the present disclosure.

FIGS. 13 through 17 illustrate flowcharts showing methods that support random access occasions for connected and initial access operating modes in accordance with one or more aspects of the present disclosure.

### DETAILED DESCRIPTION

Wireless devices, including user equipments (UEs) and network entities, may communicate using half-duplex operation, which may support separate, non-simultaneous transmission or reception of downlink or uplink transmissions. Additionally, or alternatively, UEs and network entities may communicate using full-duplex operation, which may support simultaneous transmission and reception of downlink and uplink transmissions. Subband full-duplex (SBFD) operation, which is a type of full-duplex operation that supports simultaneous transmission and reception of downlink and uplink transmissions on a subband basis. That is, the wireless devices may communicate uplink and downlink transmissions simultaneously (or at least using partially or full overlapping time resources), using different frequency subbands.

In some examples, a UE supporting half-duplex operation and a network entity supporting full-duplex operation may communicate via SBFD symbols (or other time resources). The network entity may enable a same set of random access occasions associated with a set of uplink symbols for the UE to use for performing initial access procedures and connected mode procedures (e.g., handover, beam failure recovery (BFR)). However, if an error (e.g., a switching delay, traffic latency) or interference occurs during the initial access procedure (which may occur before connected mode procedures) or if initial access procedures are being performed by other UEs, the initial access procedures may fail, which may result in increased latency, wasted network resources, among other issues. In some cases, initial access procedures may be performed by UEs in a non-connected mode such as in an inactive or idle mode.

The techniques described herein support utilizing different sets of random access occasions for connected mode operation for a UE. The UE may receive an indication of a set of random access occasions for the connected mode operation for the UE, the set of random access occasions including one or more SBFD symbols and one or more uplink symbols. The SBFD symbols may include subbands allocated for uplink communications, downlink communications, flexible communications, or any combination thereof. In some cases, the set of random access occasions may include separate subsets of random access occasions associated with the SBFD symbols within an uplink subband or the uplink symbols. Based on being in a connected operating mode, the UE may transmit a random access message (e.g., or perform connected mode procedures including handover, BFR) via the set of random access occasions. In some examples, the UE may also use the subset of random access occasions associated with the uplink symbols for initial access procedures while operating in an initial access operating mode.

Aspects of the disclosure are initially described in the context of wireless communications systems. Aspects of the disclosure are then described in the context of resource configurations and process flows. Aspects of the disclosure are further illustrated by and described with reference to apparatus diagrams, system diagrams, and flowcharts that relate to random access occasions for connected and initial access operating modes.

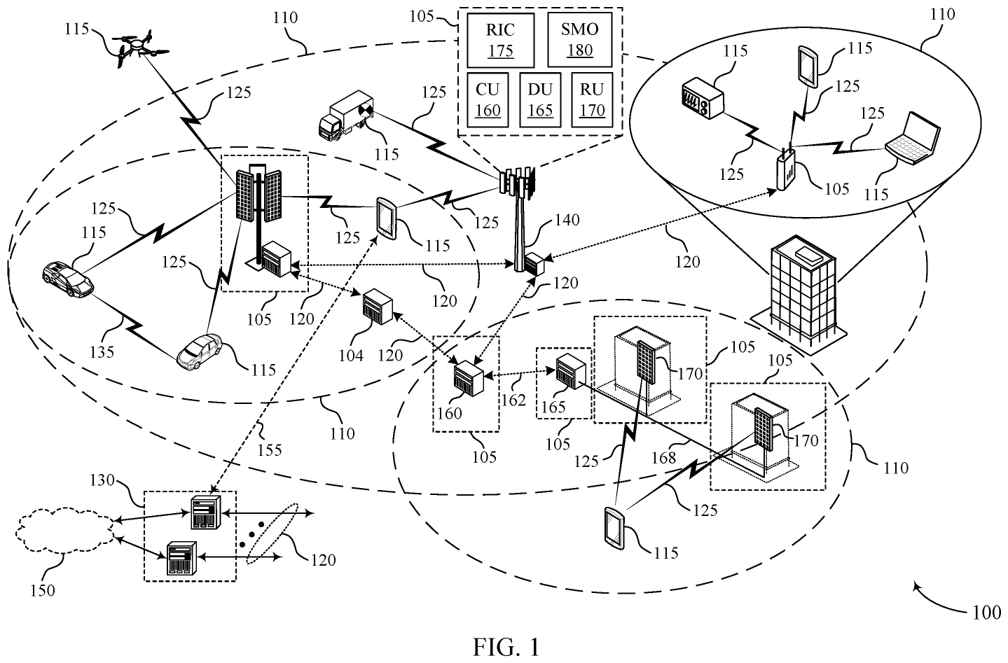

FIG. 1 illustrates an example of a wireless communications system 100 that supports random access occasions for connected and initial access operating modes in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support random access occasions for connected and initial access operating modes as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Some UEs 115 and network entities 105 may support SBFD operation, where the wireless devices may perform simultaneous transmission and reception of downlink and uplink transmissions on a subband basis. That is, the wireless devices may communicate uplink and downlink transmissions simultaneously, using different frequency subbands. In some cases, a UE 115 and a network entity 105 may communicate via SBFD symbols while the UE 115 may support half-duplex operation and the network entity 105 may support full-duplex operation for dynamic or flexible TDD.

In some examples, the network entity 105 supporting full-duplex communications may communicate with two or more UEs 115 at a same time. In such cases, the network entity 105 and the UEs 115 may experience self-interference directly from a transmitter chain to a receiver chain (which may be separated by a distance d), or a transmission from the network entity 105 may reflect off a reflector or clutter (e.g., a building, trees, or other objects that may interfere with a transmission) back to a receive beam corresponding to the UEs 115.

In some cases, the SBFD communications may be based on a TDD carrier or intra-band carrier aggregation. In either case, the network entity 105 may use different subbands to transmit and receive communications with two UEs 115 simultaneously. Supporting such SBFD-based communications may increase an uplink duty cycle, which may improve uplink coverage and reduce latency (for example, as a UE 115 may transmit an uplink signal in an uplink subband via legacy downlink or flexible slots). In addition, the supported SBFD operation may enhance system capacity, resource utilization, and spectral efficiency, and enable flexible and dynamic uplink and downlink resource adaptation according to uplink and downlink traffic in a robust manner.

The wireless communications system 100 may support the use of different sets of random access occasions for connected mode operation for a UE 115. The UE 115 may receive an indication of a set of random access occasions for the connected mode operation for the UE 115, the set of random access occasions including one or more SBFD symbols and one or more uplink symbols. The SBFD symbols may include subbands allocated for uplink communications, downlink communications, flexible communications, or any combination thereof. In some cases, the set of random access occasions may include separate subsets of random access occasions associated with the SBFD symbols within an uplink subband or the uplink symbols. Based on being in a connected operating mode, the UE 115 may transmit a random access message via the set of random access occasions. In some examples, the UE 115 may also use the subset of random access occasions associated with the uplink symbols for initial access while operating in an initial access operating mode.

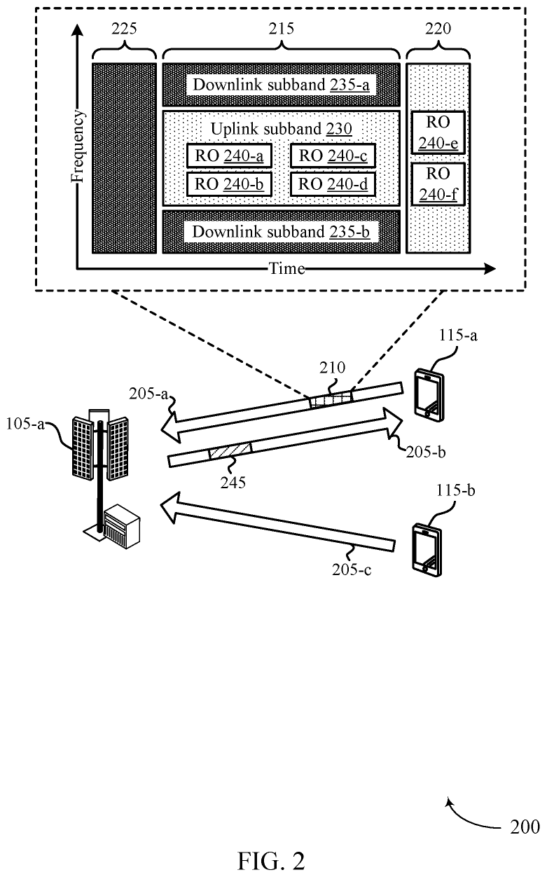

FIG. 2 illustrates an example of a wireless communications system 200 that supports random access occasions for connected and initial access operating modes in accordance with one or more aspects of the present disclosure. In some examples, the wireless communications system 200 may implement aspects of the wireless communications system 100 or may be implemented by aspects of the wireless communications system 100. For example, the wireless communications system 200 may include a UE 115-a, a UE 115-b, and a network entity 105-a, which may be examples of corresponding devices described herein. The UE 115-a and UE 115-b may support half-duplex communications (e.g., the UE 115-a may support uplink or downlink communications at a given time and the UE 115-b may support uplink communications), and the network entity 105-a may support full-duplex communications (e.g., performing uplink and downlink communications with the UE 115-a and the UE 115-b simultaneously. As such, the UE 115-a, the UE 115-b, and the network entity 105-a may support SBFD communications.

The wireless communications system 200 may support communications between the UE 115-a, the UE 115-b, and the network entity 105-a. For example, the UE 115-a and the network entity 105-a may perform downlink communications via a communications link 205-a (e.g., a downlink) and uplink communications via a communications link 205-b (e.g., an uplink). In addition, the UE 115-b may perform uplink communications with the network entity 105-a via a communication link 205-c (e.g., an uplink). The communications links 205 may be examples of communications links 125 described herein with reference to FIG. 1. The network entity 105-a may communicate with the UEs 115 via SBFD symbols, where a SBFD symbol may include one or more subbands allocated for uplink and one or more subbands allocated for downlink or flexible communications. For example, the network entity 105-a may use uplink subbands of a SBFD symbol to receive uplink messages from the UE 115-a and the UE 115-b (e.g., an uplink UE) and downlink subbands of the SBFD symbol to transmit downlink messages to the UE 115-a.

In some examples, the network entity 105-a may enable random access occasions for the UE 115-a to use for initial access procedures and connected mode procedures (e.g., handover, BFR). In some cases, the network entity 105-a may indicate different sets of random access occasions for contention-free random access (CFRA) random access channel (RACH) transmissions when the UE 115-a is in a connected operating mode (e.g., an RRC connected mode) and for initial access procedures when the UE 115-a is in an initial access operating mode (e.g., when UE 115-a performs initial cell access or is in an RRC inactive mode or RRC idle mode). That is, the UE 115-a may use different random access occasions using SBFD symbols for initial access than resources (e.g., SBFD symbols) allocated for connected mode operations.

For handover, BFR, or other connected mode procedures, the network entity 105-a may indicate a separate set of random access occasions that may include SBFD symbols and non-SBFD symbols (e.g., legacy uplink symbols) for CFRA-based RACH when the UE 115-a is operating in a connected mode. For example, the network entity 105-a may transmit an indication 210 (a first indication) of a set of random access occasions for connected mode operation for the UE 115-a. The set of random access occasions may span one or more SBFD symbols 215 and one or more uplink symbols 220, where an SBFD symbol may include one or more uplink subbands 230 (subbands allocated for uplink communications) and one or more downlink subbands 235 (subbands allocated for downlink or flexible communications). For example, the network entity 105-a and the UE 115-a may support a resource configuration that includes an uplink symbol 220 (or an uplink slot), a downlink symbol 225 (or a downlink slot), and an SBFD symbol 215 that includes an uplink subband 230, a downlink subband 235-a, and a downlink subband 235-b. The uplink symbol 220 and the downlink symbol 225 may be examples of legacy half-duplex symbols.

In some cases, the network entity 105-a may indicate a set of random access occasions across one or more SBFD symbols (including the SBFD symbol 215) and one or more non-SBFD symbols (e.g., the uplink symbol 220) for the CFRA-based RACH for the connected mode operation of the UE 115-a with a same frequency allocation. For example, the set of random access occasions may include random access occasions (ROs) 240-a, 240-b, 240-c, and 240-d in the uplink subband 230 of the SBFD symbol 215 and random access occasions 240-e and 240-f in the uplink symbol 220, where all of the random access occasions 240 may be of a same size (e.g., include a same time and frequency resource allocation).

Alternatively, the network entity 105-a may indicate two subsets of random access occasions (of the set of random access occasions) for the CFRA-based RACH while the UE 115-a is in a connected operating mode. The network entity 105-a may enable a first subset for the SBFD symbol 215 within the uplink subband 230 and a second subset for the uplink symbol 220 within a wideband. For example, the first subset of random access occasions may include the random access occasions 240-a, 240-b, 240-c, and 240-d, and the second subset of random access occasions may include the random access occasions 240-e and 240-f. In such cases, the random access occasions 240 in the first subset and the second subset may be different sizes (e.g., include a different time and frequency resource allocation). The network entity 105-a may indicate the two subsets of random access occasions via same a control message (e.g., the indication 210) or two separate control messages.

In some cases, the UE 115-a may use the same set of random access occasions in the uplink symbol 220 to perform initial access procedures while in an initial access operating mode and to perform connected mode procedures (e.g., handover, BFR) while in a connected operating mode. That is, the network entity 105-a may enable a set of random access occasions in one or more uplink symbols (e.g., the random access occasion 240-e and the random access occasion 240-f in the uplink symbol 220) for initial access and connected mode operation for the UE 115-a. In this way, the initial access and connected mode operations may share a same set of random access occasions in the uplink symbol 220 (and not the SBFD symbol 215).

In some examples, random access occasions 240 configured for initial access operation for the UE 115-a may be associated with an initial BWP of a primary cell (PCell) (e.g., a BWP 0). Alternatively, random access occasions 240 configured for the connected mode operation for the UE 115-a may be associated with other BWPs of the PCell or other cells, where the random access occasions 240 for the connected mode operation may be different than the random access occasions 240 for the initial access operation. That is, a set of random access occasions for the initial access operation may be associated with an initial BWP of the PCell and a set of random access occasions for the connected mode operation may be associated with a first set of BWPs for the primary cell or a second set of BWPs of a second cell (e.g., a different or other cell). In this way, different BWPs may be associated with different random access occasions, and the network entity 105-a may enable random access occasions 240 across SBFD symbols 215 and non-SBFD symbols (e.g., the uplink symbol 220) for connected mode operation in BWPs of a PCell and other cells.

In such cases, the network entity 105 may configure one or multiple sets of random access occasions across SBFD symbols, non-SBFD symbols (e.g., the uplink symbol 220), or both as described herein. For example, the network entity 105-a may configure one set of random access occasions (including the random access occasions 240-a, 240-b, 240-c, 240-d, 240-e, and 240-f) across the SBFD symbols (within the uplink subband 230 of the SBFD symbol 215) and the non-SBFD symbols (the uplink symbol 220) for the connected mode operation within a same frequency allocation. The set of random access occasions may be associated with one or more BWPs of a PCell and other cells. Alternatively, the network entity 105-a may configure the first subset of random access occasions (including the random access occasions 240-a, 240-b, 240-c, and 240-d) across SBFD symbols for the connected mode operation for some BWPs of the cells and a second subset of random access occasions (including the random access occasions 240-e and 240-f) across non-SBFD symbols for the connected mode operation for some BWPs of the cells. Additionally, the UE 115-a may use the prioritization rule described herein for the sets of random access occasions configured for the different BWPs and cells.

The UE 115-a may transmit a random access message 245 via the set of random access occasions (including at least some of the random access occasions 240-a, 240-b, 240-c, 240-d, 240-e, and 240-f based on an operating mode of the UE 115-a being a connected operating mode (e.g., an RRC connected mode). For example, the UE 115-a may transmit the random access message 245 for a handover procedure or a BFR procedure based on the operating mode of the UE 115-a being a connected operating mode. Alternatively, if some of the random access occasions 240 in the uplink symbol 220 are configured for initial access operation as well as connected mode operation, the UE 115-a may perform an initial access procedure via the random access occasions 240 based on the UE 115-a operating in an initial access operating mode (e.g., an RRC inactive mode).

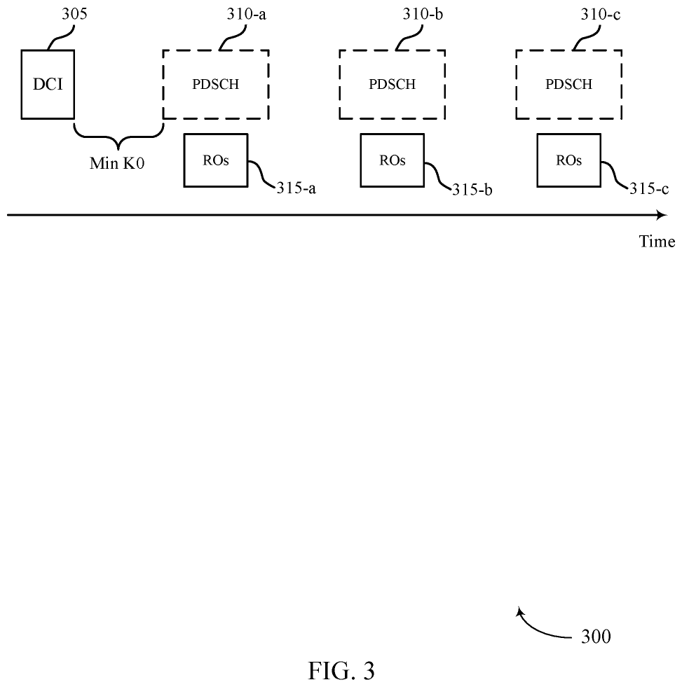

FIG. 3 illustrates an example of a resource configuration 300 that supports random access occasions for connected and initial access operating modes in accordance with one or more aspects of the present disclosure. In some examples, the resource configuration 300 may be implemented by wireless communications systems 100 and 200. For example, the resource configuration 300 may be implemented by a UE 115 and a network entity 105 as described with reference to FIGS. 1 and 2. In some examples, the resource configuration 300 may indicate whether the UE 115 (that supports half-duplex communications) is to prioritize transmission of uplink messages or reception of downlink messages (e.g., a physical downlink shared channel (PDSCH) 310) when both message types are scheduled within a same set of random access occasions 315 (e.g., ROs).

As described herein with reference to FIG. 2, a network entity 105 may enable a set of random access occasions 315 for a UE 115 in a connected operating mode, where the set of random access occasions 315 may span one or more SBFD symbols (including uplink and downlink or flexible subbands) and one or more non-SBFD symbols (e.g., legacy uplink symbols in which all subbands within the non-SBFD symbol are allocated for a given communication direction (either uplink, downlink, or flexible)). The UE 115 may transmit a random access message or perform some other connected-mode operation (e.g., a handover, BFR) via the set of random access occasions 315. In some examples, the UE 115 may operate in a connected mode, however, may not have any uplink messages to transmit (e.g., a handover request or a message related to a beam failure) via the set of random access occasions 315 in an uplink subband of an SBFD symbol. In such cases, the network entity 105 may configure to use the set of random access occasions 315 for downlink message (e.g., PDSCH) reception, and the UE 115 may use a prioritization rule to determine whether to use the set of random access occasions 315 for the downlink message reception.

In some examples, the UE 115 may receive control information, such as downlink control information (DCI) 305, that schedules a downlink message via a periodic downlink occasion, a semi-persistent downlink occasion, or an aperiodic downlink occasion. The scheduled downlink message may be a PDSCH 310, a physical downlink control channel (PDCCH), or a CSI-RS, among other downlink messages. In addition, the downlink message may at least partially overlap with a set of random access occasions 315 associated with one or more SBFD symbols and a set of corresponding gap symbols in the time domain. That is, the UE 115 (which may be an SBFD-aware UE capable of communicating via SBFD symbols and slots) may be scheduled with a downlink signal or message (e.g., a PDSCH 310, a PDCCH, a CSI-RS) via one or more valid random access occasions and corresponding gap symbols.

To improve resource utilization, reduce downlink and uplink switching delays, and reduce traffic latency, the UE 115 may apply a relaxed downlink and uplink multiplexing rule to the set of random access occasions 315 enabled by the network entity 105 for SBFD symbols. That is, a downlink and uplink channel or reference signal multiplexing restriction rule may be relaxed for an SBFD-aware UE on SBFD symbols or slots. The UE 115 may apply the rule to sets of random access occasions 315 included in SBFD symbols and enabled for the UE 115 when operating in a connected operating mode (e.g., for CFRA-based handover and BFR), which may be different from a set of random access occasions 315 enabled for the UE 115 when operating in an initial access mode.

In some examples, the DCI 305 may schedule transmission of a PDSCH 310-a, a PDSCH 310-b, and a PDSCH 310-c, which may overlap with a set of random access occasions 315-a, a set of random access occasions 315-b, and a random access occasions 315-c, respectively, where the random access occasions 315 may be configured for the UE 115 in SBFD symbols to use for connected mode operation. There may be a minimum scheduling offset of KO between the DCI 305 and the PDSCH 310-a. Using a prioritization rule defined for downlink and uplink channels and reference signals scheduled in a same SBFD symbol or slot, the UE 115 may determine whether to utilize a set of random access occasions 315 for uplink message transmission (including random access message transmissions, or transmissions for handover or BFR procedures) or downlink message reception (e.g., including a PDSCH 310).

In some examples, the UE 115 may prioritize reception of a PDSCH 310 via the set of random access occasions 315 over transmission of a random access message via the set of random access occasions 315 based on the prioritization rule. For example, when the PDSCH 310-a is multiplexed with the set of random access occasions 315-a, which may be configured for connected mode operation of the UE 115, the ULE 115 may prioritize reception of the PDSCH 310-a if no random access messages are transmitted by the same UE 115 via the set of random access occasions 315-a (the random access messages being associated with handover, BFR, or other connected mode operation). For a downlink grant PDSCH to be prioritized, the scheduling offset KO may satisfy a minimum threshold.

Alternatively, the UE 115 may prioritize transmission of the random access message via the set of random access occasions 315 over reception of a PDSCH 310 via the set of random access occasions 315 based on the prioritization rule. For example, if the UE 115 is to transmit a random access message associated with handover, BFR, or other connected mode operation via the set of random access occasions 315-a, the UE 115 may prioritize the random access message instead of the PDSCH 310-a scheduled by the DCI 305.

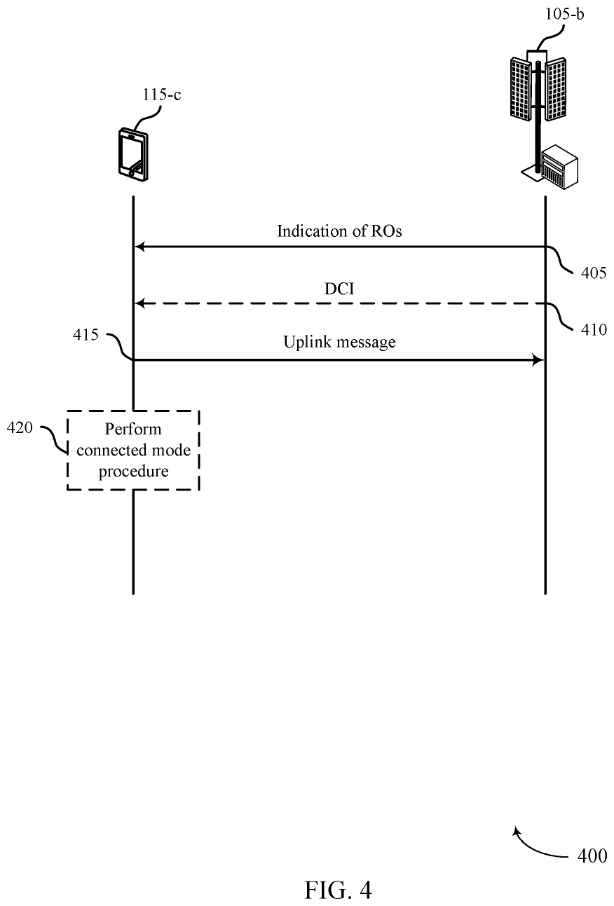

FIG. 4 illustrates an example of a process flow 400 that supports random access occasions for connected and initial access operating modes in accordance with one or more aspects of the present disclosure. The process flow 400 may implement aspects of wireless communications systems 100 and 200, or may be implemented by aspects of the wireless communications system 100 and 200. For example, the process flow 400 may illustrate operations between a UE 115-c and a network entity 105-b, which may be examples of corresponding devices described herein. In the following description of the process flow 400, the operations between the UE 115-c and the network entity 105-b may be transmitted in a different order than the example order shown, or the operations performed by the UE 115-c and the network entity 105-b may be performed in different orders or at different times. Some operations may also be omitted from the process flow 400, and other operations may be added to the process flow 400.

At 405, the UE 115-c may receive, from the network entity 105-b, a first indication of a set of random access occasions for connected mode operation for the UE 115-c (e.g., RRC connected mode), the set of random access occasions including one or more SBFD symbols and one or more uplink symbols (e.g., non-SBFD symbols), where an SBFD symbol includes one or more subbands allocated for uplink and one or more subbands allocated for downlink or flexible. In some examples, the set of random access occasions may include a first subset of random access occasions associated with the one or more SBFD symbols within an uplink subband and a second subset of random access occasions associated with the one or more uplink symbols. That is, the set of random access occasions may span SBFD symbols, non-SBFD symbols, or both. In some examples, the indication may provide random access occasions allocated for initial access operations, or an indication of random access occasions for initial access may be provided to the UE 115-c in a message separate from the indication at 405.

At 410, the UE 115-c may receive, from the network entity 105-b, DCI that schedules a downlink message via a periodic downlink occasion, a semi-persistent downlink occasion, or an aperiodic downlink occasion, where the scheduled downlink message at least partially overlaps the set of random access occasions and a set of corresponding gap symbols in time domain. That is, the DCI may schedule a downlink message via the set of random access occasions which are configured for connected mode operation for the UE 115-c.

At 415, the UE 115-c may a random access message via the set of random access occasions based on an operating mode of the UE 115-c being a connected operating mode (e.g., the RRC connected operating mode). In such cases, the UE 115-c may prioritize the transmission of the random access message via the set of random access occasions over reception of the downlink message via the set of random access occasions.

At 420, in transmitting the random access message, the UE 115-c may perform a handover procedure or a BFR procedure via the set of random access occasions based on the operating mode of the UE 115-c being the connected operating mode. That is, the random access message may be transmitted as part of the handover procedure or the BFR procedure.

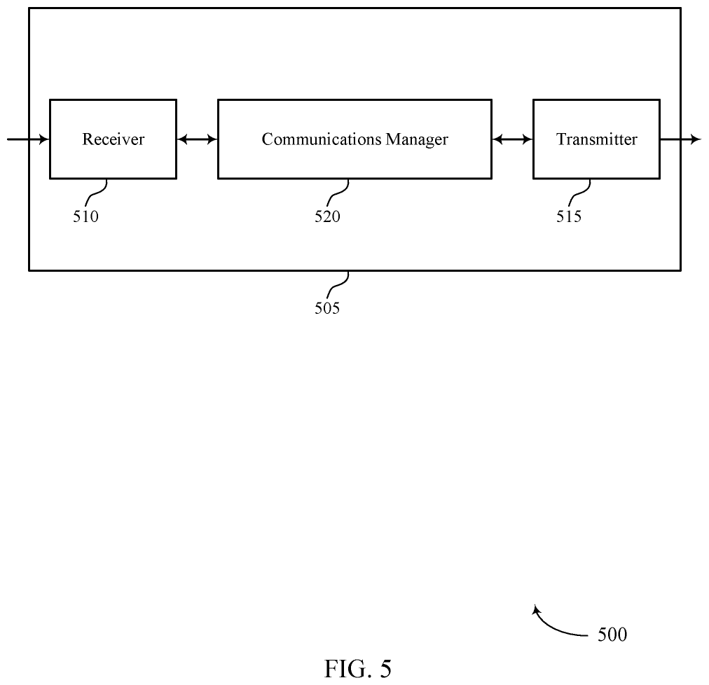

FIG. 5 illustrates a block diagram 500 of a device 505 that supports random access occasions for connected and initial access operating modes in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to random access occasions for connected and initial access operating modes). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to random access occasions for connected and initial access operating modes). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of random access occasions for connected and initial access operating modes as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for receiving a first indication of a set of random access occasions for connected mode operation for the UE, the set of random access occasions including one or more SBFD symbols and one or more uplink symbols, where a SBFD symbol includes one or more subbands allocated for uplink and one or more subbands allocated for downlink or flexible. The communications manager 520 may be configured as or otherwise support a means for transmitting a random access message via the set of random access occasions based on an operating mode of the UE being a connected operating mode.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for enabling random access occasions for initial access operation and connected mode operation across SBFD symbols, non-SBFD symbols, or both, which may improve resource utilization, reduce downlink and uplink switching delays, reduce traffic latency, and improve communications.

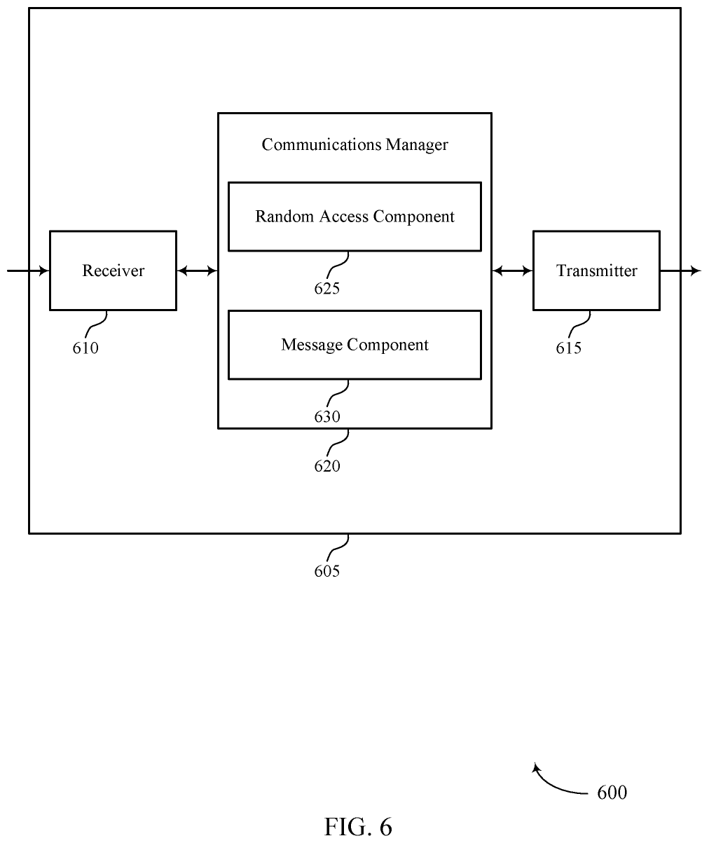

FIG. 6 illustrates a block diagram 600 of a device 605 that supports random access occasions for connected and initial access operating modes in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to random access occasions for connected and initial access operating modes). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to random access occasions for connected and initial access operating modes). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of random access occasions for connected and initial access operating modes as described herein. For example, the communications manager 620 may include a random access component 625 a message component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The random access component 625 may be configured as or otherwise support a means for receiving a first indication of a set of random access occasions for connected mode operation for the UE, the set of random access occasions including one or more SBFD symbols and one or more uplink symbols, where a SBFD symbol includes one or more subbands allocated for uplink and one or more subbands allocated for downlink or flexible. The message component 630 may be configured as or otherwise support a means for transmitting a random access message via the set of random access occasions based on an operating mode of the UE being a connected operating mode.

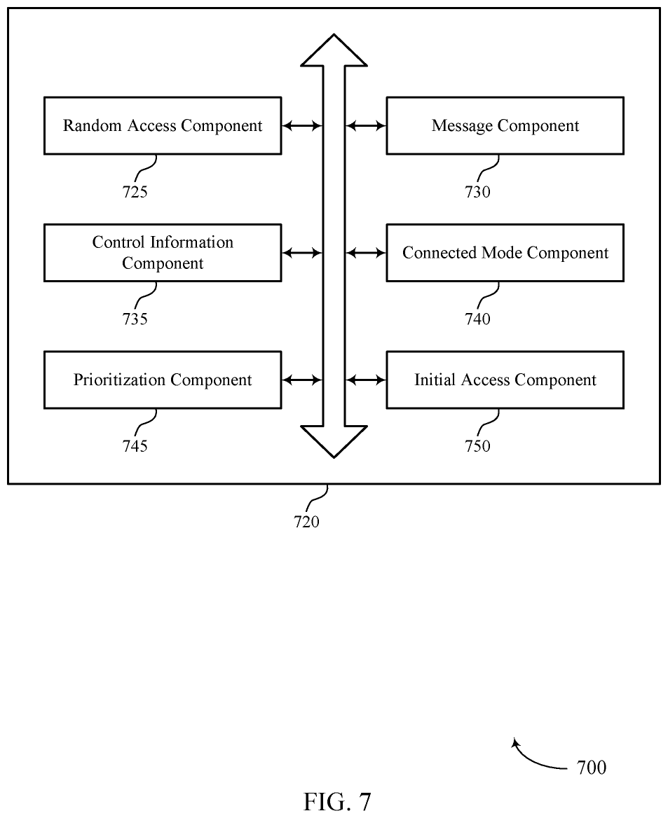

FIG. 7 illustrates a block diagram 700 of a communications manager 720 that supports random access occasions for connected and initial access operating modes in accordance with one or more aspects of the present disclosure. The communications manager 720 may be an example of aspects of a communications manager 520, a communications manager 620, or both, as described herein. The communications manager 720, or various components thereof, may be an example of means for performing various aspects of random access occasions for connected and initial access operating modes as described herein. For example, the communications manager 720 may include a random access component 725, a message component 730, a control information component 735, a connected mode component 740, a prioritization component 745, an initial access component 750, or any combination thereof. Each of these components may communicate, directly or indirectly, with one another (e.g., via one or more buses).

The communications manager 720 may support wireless communication at a UE in accordance with examples as disclosed herein. The random access component 725 may be configured as or otherwise support a means for receiving a first indication of a set of random access occasions for connected mode operation for the UE, the set of random access occasions including one or more SBFD symbols and one or more uplink symbols, where a SBFD symbol includes one or more subbands allocated for uplink and one or more subbands allocated for downlink or flexible. The message component 730 may be configured as or otherwise support a means for transmitting a random access message via the set of random access occasions based on an operating mode of the UE being a connected operating mode.

In some examples, the set of random access occasions includes a first subset of random access occasions associated with the one or more SBFD symbols within an uplink subband and a second subset of random access occasions associated with the one or more uplink symbols.

In some examples, the control information component 735 may be configured as or otherwise support a means for receiving control information that schedules a downlink message via a periodic downlink occasion, a semi-persistent downlink occasion, or an aperiodic downlink occasion, where the scheduled downlink message at least partially overlaps the set of random access occasions and a set of corresponding gap symbols in time domain.

In some examples, the prioritization component 745 may be configured as or otherwise support a means for prioritizing reception of the downlink message via the set of random access occasions over transmission of the random access message via the set of random access occasions based on a prioritization rule.

In some examples, the prioritization component 745 may be configured as or otherwise support a means for prioritizing transmission of the random access message via the set of random access occasions over reception of the downlink message based on a prioritization rule.

In some examples, the random access component 725 may be configured as or otherwise support a means for receiving a second indication of a second set of random access occasions for initial access operation for the UE, the second set of random access occasions including one or more uplink symbols.

In some examples, the second set of random access occasions for the initial access operation is associated with an initial BWP of a PCell and the set of random access occasions for the connected mode operation is associated with a first set of BWPs of the PCell or with a second set of BWPs of a second cell.

In some examples, the initial access component 750 may be configured as or otherwise support a means for performing an initial access procedure via the second set of random access occasions for the initial access operation based on the operating mode of the UE being an initial access operating mode.

In some examples, the connected mode component 740 may be configured as or otherwise support a means for performing, via the set of random access occasions, a handover procedure or a BFR procedure based on the operating mode of the UE being the connected operating mode, where the random access message is transmitted as part of the handover procedure or the BFR procedure.

In some examples, the random access component 725 may be configured as or otherwise support a means for receiving a second indication of a second set of random access occasions for the connected mode operation and initial access operation for the UE, where the second set of random access occasions includes the one or more uplink symbols. In some examples, a network entity supports SBFD operation and the UE supports half-duplex operation.

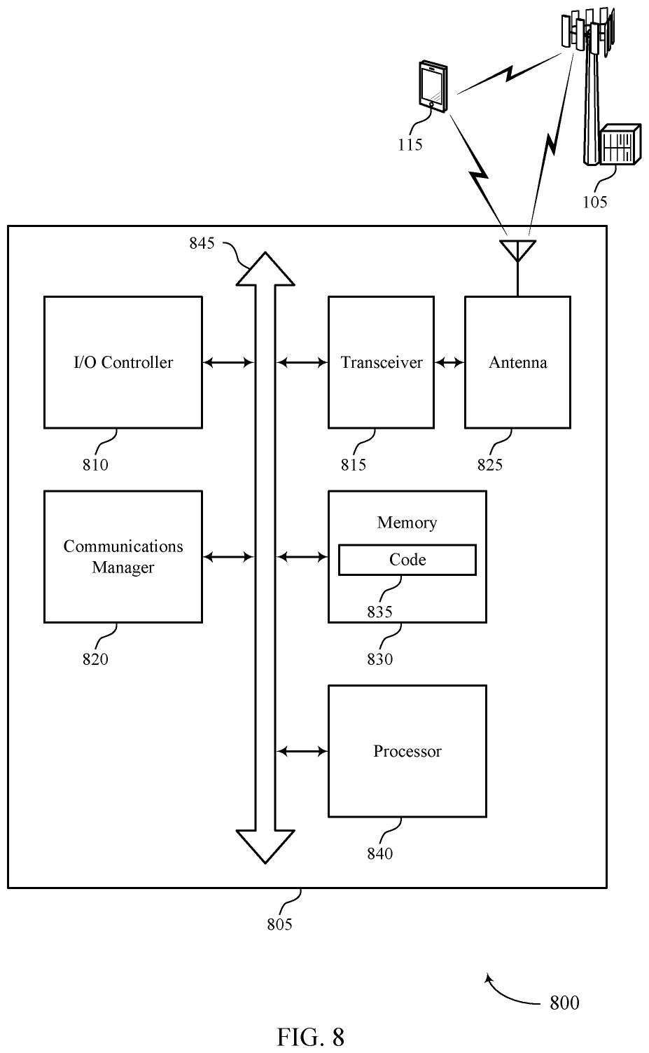

FIG. 8 illustrates a diagram of a system 800 including a device 805 that supports random access occasions for connected and initial access operating modes in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting random access occasions for connected and initial access operating modes). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving a first indication of a set of random access occasions for connected mode operation for the UE, the set of random access occasions including one or more SBFD symbols and one or more uplink symbols, where a SBFD symbol includes one or more subbands allocated for uplink and one or more subbands allocated for downlink or flexible. The communications manager 820 may be configured as or otherwise support a means for transmitting a random access message via the set of random access occasions based on an operating mode of the UE being a connected operating mode.

By including or configuring the communications manager 820 in accordance with examples as described herein, the device 805 may support techniques for enabling random access occasions for initial access operation and connected mode operation across SBFD symbols, non-SBFD symbols, or both, which may improve resource utilization, reduce downlink and uplink switching delays, reduce traffic latency, and improve communications.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of random access occasions for connected and initial access operating modes as described herein, or the processor 840 and the memory 830 may be otherwise configured to perform or support such operations.

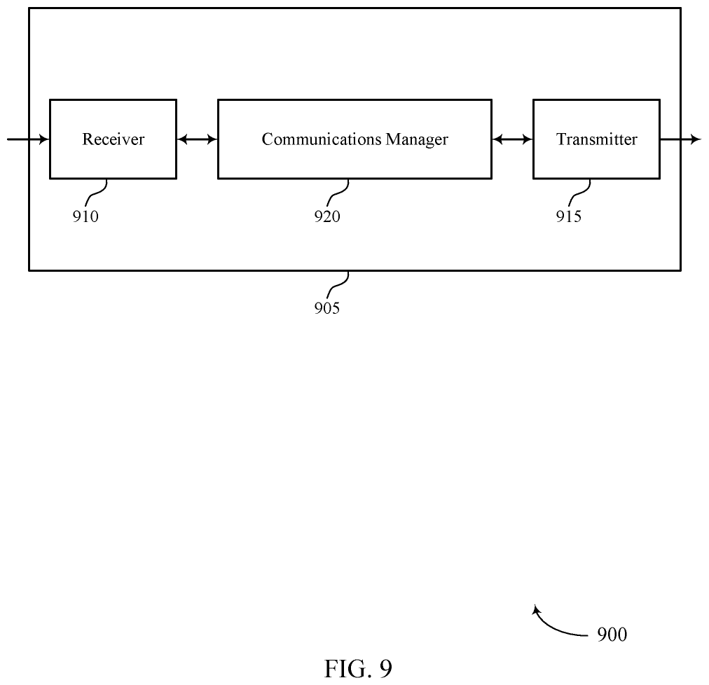

FIG. 9 illustrates a block diagram 900 of a device 905 that supports random access occasions for connected and initial access operating modes in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of random access occasions for connected and initial access operating modes as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. For example, the communications manager 920 may be configured as or otherwise support a means for transmitting a first indication of a set of random access occasions for connected mode operation for a UE, the set of random access occasions including one or more SBFD symbols and one or more uplink symbols, where a SBFD symbol includes one or more subbands allocated for uplink and one or more subbands allocated for downlink or flexible. The communications manager 920 may be configured as or otherwise support a means for receiving a random access message via the set of random access occasions based on an operating mode of the UE being a connected operating mode.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for enabling random access occasions for initial access operation and connected mode operation across SBFD symbols, non-SBFD symbols, or both, which may improve resource utilization, reduce downlink and uplink switching delays, reduce traffic latency, and improve communications.

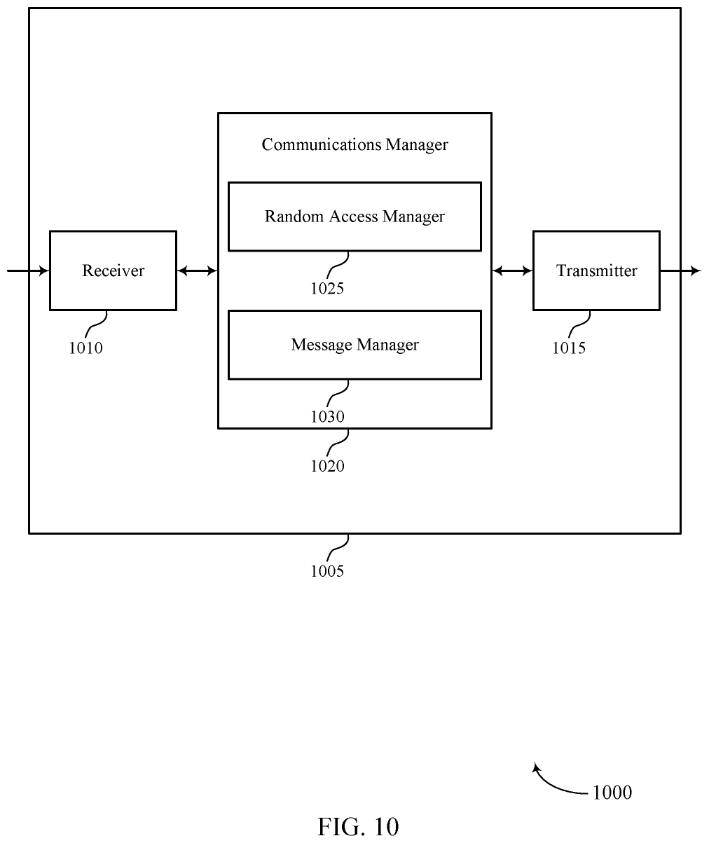

FIG. 10 illustrates a block diagram 1000 of a device 1005 that supports random access occasions for connected and initial access operating modes in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of random access occasions for connected and initial access operating modes as described herein. For example, the communications manager 1020 may include a random access manager 1025 a message manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. The random access manager 1025 may be configured as or otherwise support a means for transmitting a first indication of a set of random access occasions for connected mode operation for a UE, the set of random access occasions including one or more SBFD symbols and one or more uplink symbols, where a SBFD symbol includes one or more subbands allocated for uplink and one or more subbands allocated for downlink or flexible. The message manager 1030 may be configured as or otherwise support a means for receiving a random access message via the set of random access occasions based on an operating mode of the UE being a connected operating mode.

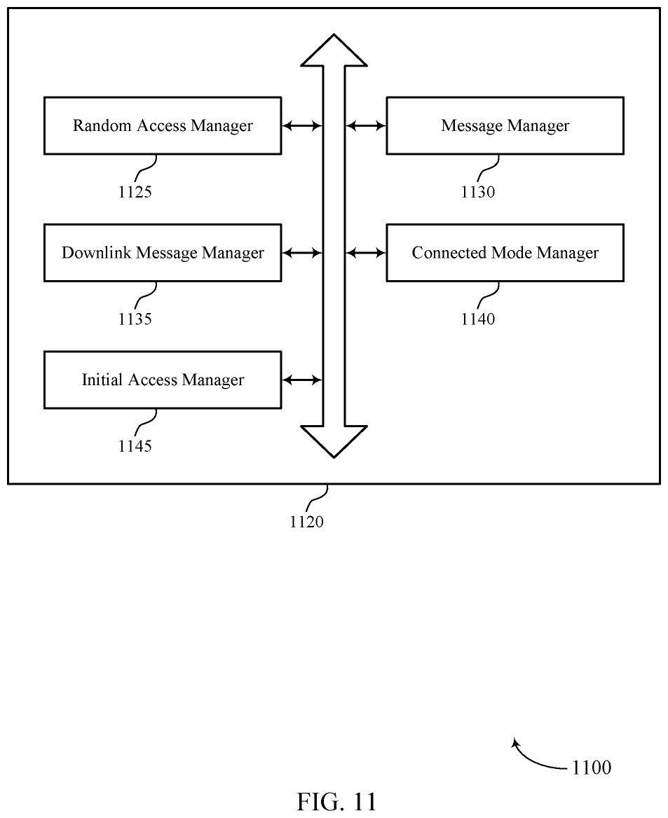

FIG. 11 illustrates a block diagram 1100 of a communications manager 1120 that supports random access occasions for connected and initial access operating modes in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of random access occasions for connected and initial access operating modes as described herein. For example, the communications manager 1120 may include a random access manager 1125, a message manager 1130, a downlink message manager 1135, a connected mode manager 1140, an initial access manager 1145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The random access manager 1125 may be configured as or otherwise support a means for transmitting a first indication of a set of random access occasions for connected mode operation for a UE, the set of random access occasions including one or more SBFD symbols and one or more uplink symbols, where a SBFD symbol includes one or more subbands allocated for uplink and one or more subbands allocated for downlink or flexible. The message manager 1130 may be configured as or otherwise support a means for receiving a random access message via the set of random access occasions based on an operating mode of the UE being a connected operating mode.

In some examples, the set of random access occasions includes a first subset of random access occasions associated with the one or more SBFD symbols within an uplink subband and a second subset of random access occasions associated with the one or more uplink symbols.

In some examples, the downlink message manager 1135 may be configured as or otherwise support a means for transmitting control information that schedules a downlink message via a periodic downlink occasion, a semi-persistent downlink occasion, or an aperiodic downlink occasion, where the scheduled downlink message at least partially overlaps the set of random access occasions and a set of corresponding gap symbols in time domain.

In some examples, the random access manager 1125 may be configured as or otherwise support a means for transmitting a second indication of a second set of random access occasions for initial access operation for the UE, the second set of random access occasions including one or more uplink symbols.

In some examples, the second set of random access occasions for the initial access operation is associated with an initial BWP of a PCell and the set of random access occasions for the connected mode operation is associated with a first set of BWPs of the PCell or a second set of BWPs of a second cell.

In some examples, the initial access manager 1145 may be configured as or otherwise support a means for performing an initial access procedure via the second set of random access occasions for the initial access operation based on the operating mode of the UE being an initial access operating mode.

In some examples, the connected mode manager 1140 may be configured as or otherwise support a means for performing, via the set of random access occasions for the connected mode operation, a handover procedure or a BFR procedure based on the operating mode of the UE being the connected operating mode, where the random access message is received as part of the handover procedure or the BFR procedure.

In some examples, the random access manager 1125 may be configured as or otherwise support a means for transmitting a second indication of a second set of random access occasions for the connected mode operation and initial access operation for the UE, where the second set of random access occasions includes the one or more uplink symbols. In some examples, the network entity supports SBFD operation and the UE supports half-duplex operation.

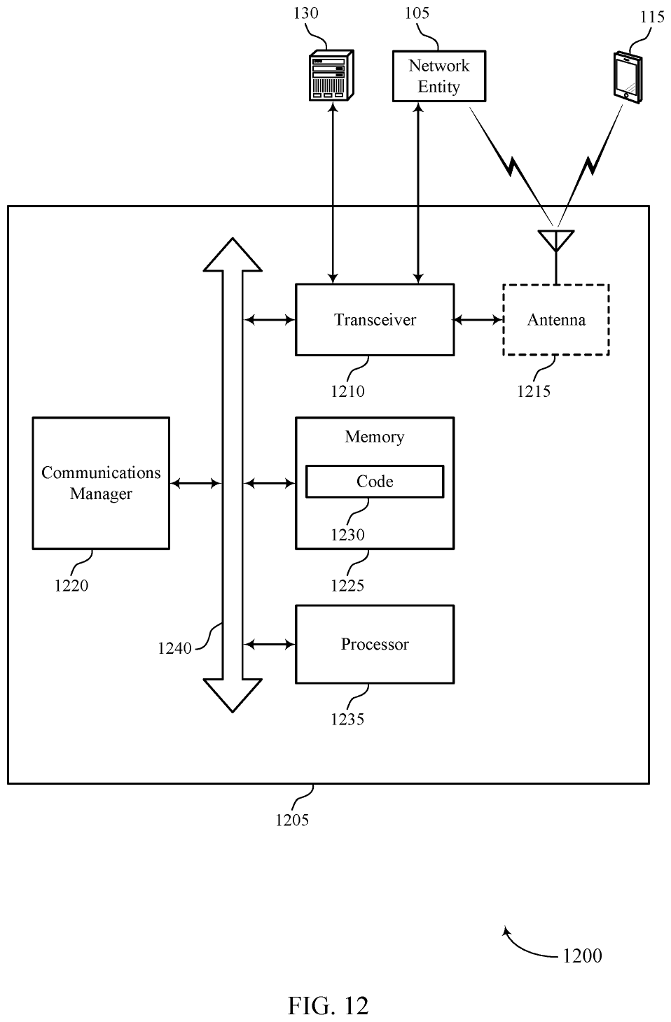

FIG. 12 illustrates a diagram of a system 1200 including a device 1205 that supports random access occasions for connected and initial access operating modes in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting random access occasions for connected and initial access operating modes). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with ULEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity in accordance with examples as disclosed herein. For example, the communications manager 1220 may be configured as or otherwise support a means for transmitting a first indication of a set of random access occasions for connected mode operation for a UE, the set of random access occasions including one or more SBFD symbols and one or more uplink symbols, where a SBFD symbol includes one or more subbands allocated for uplink and one or more subbands allocated for downlink or flexible. The communications manager 1220 may be configured as or otherwise support a means for receiving a random access message via the set of random access occasions based on an operating mode of the UE being a connected operating mode.

By including or configuring the communications manager 1220 in accordance with examples as described herein, the device 1205 may support techniques for enabling random access occasions for initial access operation and connected mode operation across SBFD symbols, non-SBFD symbols, or both, which may improve resource utilization, reduce downlink and uplink switching delays, reduce traffic latency, and improve communications.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of random access occasions for connected and initial access operating modes as described herein, or the processor 1235 and the memory 1225 may be otherwise configured to perform or support such operations.

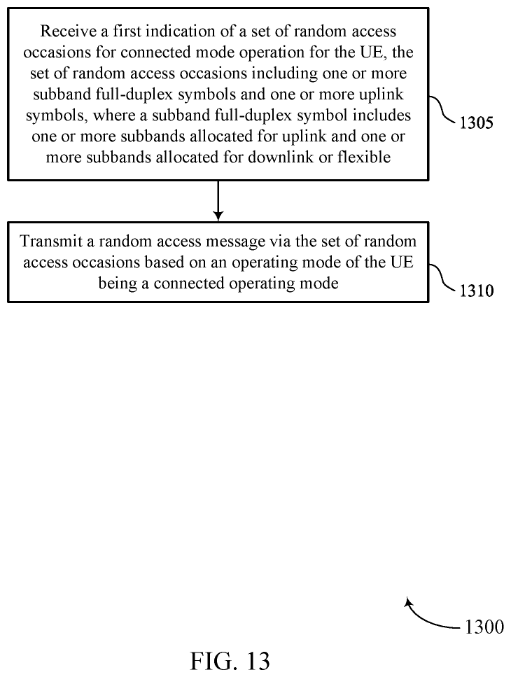

FIG. 13 illustrates a flowchart showing a method 1300 that supports random access occasions for connected and initial access operating modes in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a first indication of a set of random access occasions for connected mode operation for the UE, the set of random access occasions including one or more SBFD symbols and one or more uplink symbols, where a SBFD symbol includes one or more subbands allocated for uplink and one or more subbands allocated for downlink or flexible. The operations of 1305 may be performed in accordance with examples as disclosed herein. In some examples, aspects of the operations of 1305 may be performed by a random access component 725 as described with reference to FIG. 7.

At 1310, the method may include transmitting a random access message via the set of random access occasions based on an operating mode of the UE being a connected operating mode. The operations of 1310 may be performed in accordance with examples as disclosed herein. In some examples, aspects of the operations of 1310 may be performed by a message component 730 as described with reference to FIG. 7.

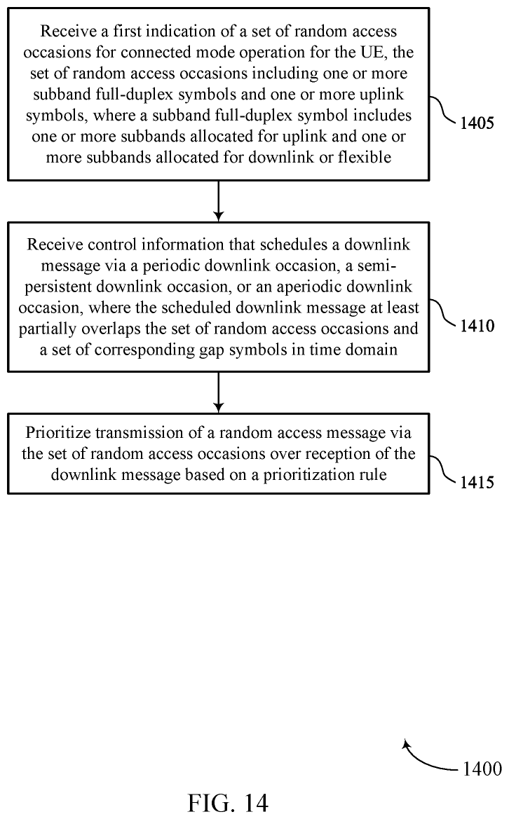

FIG. 14 illustrates a flowchart showing a method 1400 that supports random access occasions for connected and initial access operating modes in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a first indication of a set of random access occasions for connected mode operation for the UE, the set of random access occasions including one or more SBFD symbols and one or more uplink symbols, where a SBFD symbol includes one or more subbands allocated for uplink and one or more subbands allocated for downlink or flexible. The operations of 1405 may be performed in accordance with examples as disclosed herein. In some examples, aspects of the operations of 1405 may be performed by a random access component 725 as described with reference to FIG. 7.

At 1410, the method may include receiving control information that schedules a downlink message via a periodic downlink occasion, a semi-persistent downlink occasion, or an aperiodic downlink occasion, where the scheduled downlink message at least partially overlaps the set of random access occasions and a set of corresponding gap symbols in time domain. The operations of 1410 may be performed in accordance with examples as disclosed herein. In some examples, aspects of the operations of 1410 may be performed by a control information component 735 as described with reference to FIG. 7.

At 1415, the method may include prioritizing transmission of a random access message via the set of random access occasions over reception of the downlink message based on a prioritization rule. The operations of 1415 may be performed in accordance with examples as disclosed herein. In some examples, aspects of the operations of 1415 may be performed by a prioritization component 745 as described with reference to FIG. 7.

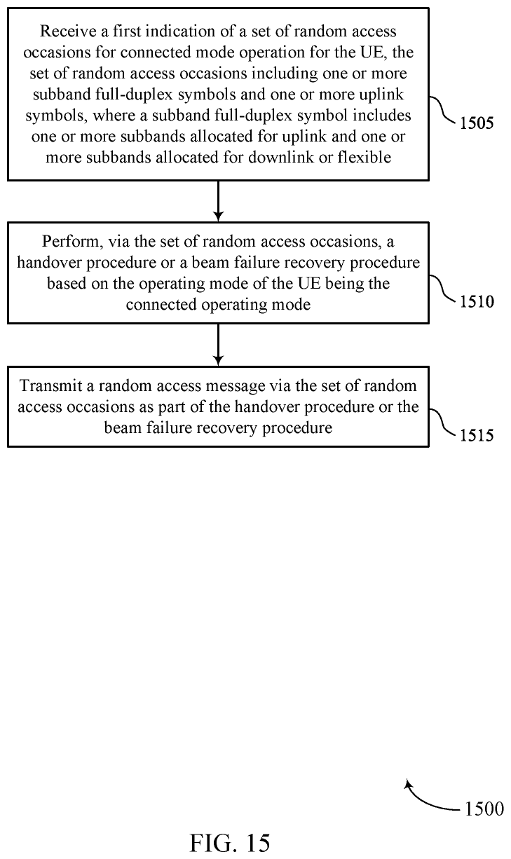

FIG. 15 illustrates a flowchart showing a method 1500 that supports random access occasions for connected and initial access operating modes in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving a first indication of a set of random access occasions for connected mode operation for the UE, the set of random access occasions including one or more SBFD symbols and one or more uplink symbols, where a SBFD symbol includes one or more subbands allocated for uplink and one or more subbands allocated for downlink or flexible. The operations of 1505 may be performed in accordance with examples as disclosed herein. In some examples, aspects of the operations of 1505 may be performed by a random access component 725 as described with reference to FIG. 7.

At 1510, the method may include performing, via the set of random access occasions, a handover procedure or a BFR procedure based on the operating mode of the UE being the connected operating mode. The operations of 1510 may be performed in accordance with examples as disclosed herein. In some examples, aspects of the operations of 1510 may be performed by a connected mode component 740 as described with reference to FIG. 7.

At 1515, the method may include transmitting a random access message via the set of random access occasions as part of the handover procedure or the BFR procedure. The operations of 1515 may be performed in accordance with examples as disclosed herein. In some examples, aspects of the operations of 1515 may be performed by a message component 730 as described with reference to FIG. 7.

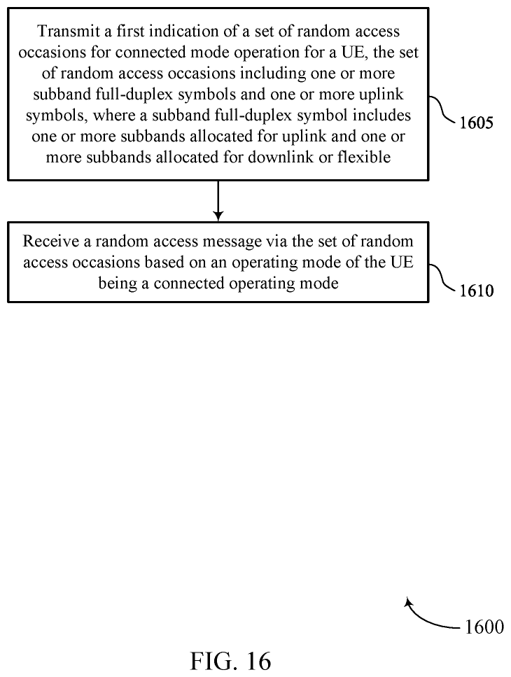

FIG. 16 illustrates a flowchart showing a method 1600 that supports random access occasions for connected and initial access operating modes in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting a first indication of a set of random access occasions for connected mode operation for a UE, the set of random access occasions including one or more SBFD symbols and one or more uplink symbols, where a SBFD symbol includes one or more subbands allocated for uplink and one or more subbands allocated for downlink or flexible. The operations of 1605 may be performed in accordance with examples as disclosed herein. In some examples, aspects of the operations of 1605 may be performed by a random access manager 1125 as described with reference to FIG. 11.

At 1610, the method may include receiving a random access message via the set of random access occasions based on an operating mode of the UE being a connected operating mode. The operations of 1610 may be performed in accordance with examples as disclosed herein. In some examples, aspects of the operations of 1610 may be performed by a message manager 1130 as described with reference to FIG. 11.

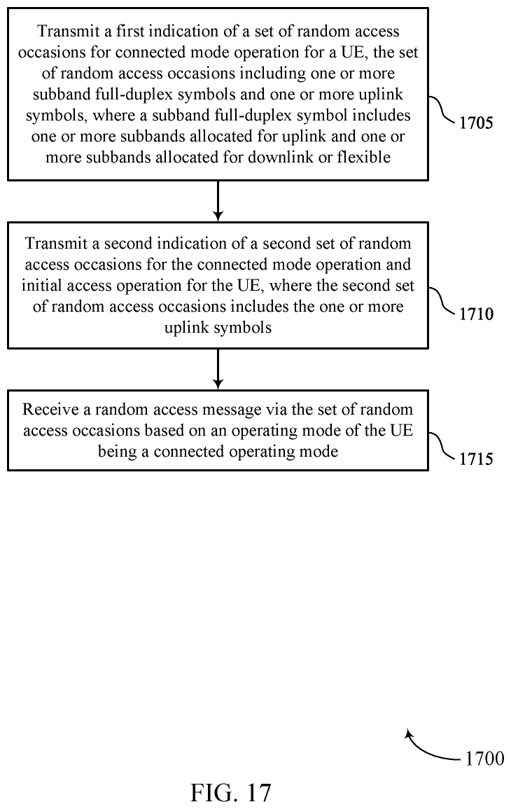

FIG. 17 illustrates a flowchart showing a method 1700 that supports random access occasions for connected and initial access operating modes in accordance with one or more aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1705, the method may include transmitting a first indication of a set of random access occasions for connected mode operation for a UE, the set of random access occasions including one or more SBFD symbols and one or more uplink symbols, where a SBFD symbol includes one or more subbands allocated for uplink and one or more subbands allocated for downlink or flexible. The operations of 1705 may be performed in accordance with examples as disclosed herein. In some examples, aspects of the operations of 1705 may be performed by a random access manager 1125 as described with reference to FIG. 11.

At 1710, the method may include transmitting a second indication of a second set of random access occasions for the connected mode operation and initial access operation for the UE, where the second set of random access occasions includes the one or more uplink symbols. The operations of 1710 may be performed in accordance with examples as disclosed herein. In some examples, aspects of the operations of 1710 may be performed by a random access manager 1125 as described with reference to FIG. 11.

At 1715, the method may include receiving a random access message via the set of random access occasions based on an operating mode of the UE being a connected operating mode. The operations of 1715 may be performed in accordance with examples as disclosed herein. In some examples, aspects of the operations of 1715 may be performed by a message manager 1130 as described with reference to FIG. 11.

The following provides an overview of aspects of the present disclosure:
Aspect 1: A method for wireless communication at a UE, comprising: receiving a first indication of a set of random access occasions for connected mode operation for the UE, the set of random access occasions comprising one or more SBFD symbols and one or more uplink symbols, wherein a SBFD symbol comprises one or more subbands allocated for uplink and one or more subbands allocated for downlink or flexible; and transmitting a random access message via the set of random access occasions based at least in part on an operating mode of the UE being a connected operating mode.
Aspect 2: The method of aspect 1, wherein the set of random access occasions comprises a first subset of random access occasions associated with the one or more SBFD symbols within an uplink subband and a second subset of random access occasions associated with the one or more uplink symbols.
Aspect 3: The method of any of aspects 1 through 2, further comprising: receiving control information that schedules a downlink message via a periodic downlink occasion, a semi-persistent downlink occasion, or an aperiodic downlink occasion, wherein the scheduled downlink message at least partially overlaps the set of random access occasions and a set of corresponding gap symbols in time domain.
Aspect 4: The method of aspect 3, further comprising: prioritizing reception of the downlink message via the set of random access occasions over transmission of the random access message via the set of random access occasions based at least in part on a prioritization rule.
Aspect 5: The method of any of aspects 3 through 4, further comprising: prioritizing transmission of the random access message via the set of random access occasions over reception of the downlink message based at least in part on a prioritization rule.
Aspect 6: The method of any of aspects 1 through 5, further comprising: receiving a second indication of a second set of random access occasions for initial access operation for the UE, the second set of random access occasions comprising one or more uplink symbols.
Aspect 7: The method of aspect 6, wherein the second set of random access occasions for the initial access operation is associated with an initial BWP of a PCell and the set of random access occasions for the connected mode operation is associated with a first set of BWPs of the PCell or with a second set of BWPs of a second cell.
Aspect 8: The method of any of aspects 6 through 7, further comprising: performing an initial access procedure via the second set of random access occasions for the initial access operation based at least in part on the operating mode of the UE being an initial access operating mode.
Aspect 9: The method of any of aspects 1 through 8, further comprising: performing, via the set of random access occasions, a handover procedure or a BFR procedure based at least in part on the operating mode of the UE being the connected operating mode, wherein the random access message is transmitted as part of the handover procedure or the BFR procedure.
Aspect 10: The method of any of aspects 1 through 9, further comprising: receiving a second indication of a second set of random access occasions for the connected mode operation and initial access operation for the UE, wherein the second set of random access occasions includes the one or more uplink symbols.
Aspect 11: The method of any of aspects 1 through 10, wherein a network entity supports SBFD operation and the UE supports half-duplex operation.
Aspect 12: A method for wireless communication at a network entity, comprising: transmitting a first indication of a set of random access occasions for connected mode operation for a UE, the set of random access occasions comprising one or more SBFD symbols and one or more uplink symbols, wherein a SBFD symbol comprises one or more subbands allocated for uplink and one or more subbands allocated for downlink or flexible; and receiving a random access message via the set of random access occasions based at least in part on an operating mode of the UE being a connected operating mode.
Aspect 13: The method of aspect 12, wherein the set of random access occasions comprises a first subset of random access occasions associated with the one or more SBFD symbols within an uplink subband and a second subset of random access occasions associated with the one or more uplink symbols.
Aspect 14: The method of any of aspects 12 through 13, further comprising: transmitting control information that schedules a downlink message via a periodic downlink occasion, a semi-persistent downlink occasion, or an aperiodic downlink occasion, wherein the scheduled downlink message at least partially overlaps the set of random access occasions and a set of corresponding gap symbols in time domain.
Aspect 15: The method of any of aspects 12 through 14, further comprising: transmitting a second indication of a second set of random access occasions for initial access operation for the UE, the second set of random access occasions comprising one or more uplink symbols.
Aspect 16: The method of aspect 15, wherein the second set of random access occasions for the initial access operation is associated with an initial BWP of a PCell and the set of random access occasions for the connected mode operation is associated with a first set of BWPs of the PCell or a second set of BWPs of a second cell.
Aspect 17: The method of any of aspects 15 through 16, further comprising: performing an initial access procedure via the second set of random access occasions for the initial access operation based at least in part on the operating mode of the UE being an initial access operating mode.
Aspect 18: The method of any of aspects 12 through 17, further comprising: performing, via the set of random access occasions for the connected mode operation, a handover procedure or a BFR procedure based at least in part on the operating mode of the UE being the connected operating mode, wherein the random access message is received as part of the handover procedure or the BFR procedure.
Aspect 19: The method of any of aspects 12 through 18, further comprising: transmitting a second indication of a second set of random access occasions for the connected mode operation and initial access operation for the UE, wherein the second set of random access occasions includes the one or more uplink symbols.
Aspect 20: The method of any of aspects 12 through 19, wherein the network entity supports SBFD operation and the UE supports half-duplex operation.
Aspect 21: An apparatus for wireless communication at a UE, comprising a processor; memory coupled with the processor; and instructions stored in the memory and executable by the processor to cause the apparatus to perform a method of any of aspects 1 through 11.
Aspect 22: An apparatus for wireless communication at a UE, comprising at least one means for performing a method of any of aspects 1 through 11.
Aspect 23: A non-transitory computer-readable medium storing code for wireless communication at a UE, the code comprising instructions executable by a processor to perform a method of any of aspects 1 through 11.
Aspect 24: An apparatus for wireless communication at a network entity, comprising a processor; memory coupled with the processor; and instructions stored in the memory and executable by the processor to cause the apparatus to perform a method of any of aspects 12 through 20.
Aspect 25: An apparatus for wireless communication at a network entity, comprising at least one means for performing a method of any of aspects 12 through 20.
Aspect 26: A non-transitory computer-readable medium storing code for wireless communication at a network entity, the code comprising instructions executable by a processor to perform a method of any of aspects 12 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive a first indication of a set of random access occasions for connected mode operation for the UE, the set of random access occasions comprising one or more subband full-duplex symbols and one or more uplink symbols, wherein a subband full-duplex symbol comprises one or more subbands allocated for uplink and one or more subbands allocated for downlink or flexible; and
transmit a random access message via the set of random access occasions based at least in part on an operating mode of the UE being a connected operating mode.

2. The apparatus of claim 1, wherein the set of random access occasions comprises a first subset of random access occasions associated with the one or more subband full-duplex symbols within an uplink subband and a second subset of random access occasions associated with the one or more uplink symbols.

3. The apparatus of claim 1, wherein the instructions are further executable by the processor to cause the apparatus to:
receive control information that schedules a downlink message via a periodic downlink occasion, a semi-persistent downlink occasion, or an aperiodic downlink occasion, wherein the scheduled downlink message at least partially overlaps the set of random access occasions and a set of corresponding gap symbols in time domain.

4. The apparatus of claim 3, wherein the instructions are further executable by the processor to cause the apparatus to:
prioritize reception of the downlink message via the set of random access occasions over transmission of the random access message via the set of random access occasions based at least in part on a prioritization rule.

5. The apparatus of claim 3, wherein the instructions are further executable by the processor to cause the apparatus to:
prioritize transmission of the random access message via the set of random access occasions over reception of the downlink message based at least in part on a prioritization rule.

6. The apparatus of claim 1, wherein the instructions are further executable by the processor to cause the apparatus to:
receive a second indication of a second set of random access occasions for initial access operation for the UE, the second set of random access occasions comprising one or more uplink symbols.

7. The apparatus of claim 6, wherein the second set of random access occasions for the initial access operation is associated with an initial bandwidth part of a primary cell and the set of random access occasions for the connected mode operation is associated with a first set of bandwidth parts of the primary cell or with a second set of bandwidth parts of a second cell.

8. The apparatus of claim 6, wherein the instructions are further executable by the processor to cause the apparatus to:
perform an initial access procedure via the second set of random access occasions for the initial access operation based at least in part on the operating mode of the UE being an initial access operating mode.

9. The apparatus of claim 1, wherein the instructions are further executable by the processor to cause the apparatus to:
perform, via the set of random access occasions, a handover procedure or a beam failure recovery procedure based at least in part on the operating mode of the UE being the connected operating mode, wherein the random access message is transmitted as part of the handover procedure or the beam failure recovery procedure.

10. The apparatus of claim 1, wherein the instructions are further executable by the processor to cause the apparatus to:
receive a second indication of a second set of random access occasions for the connected mode operation and initial access operation for the UE, wherein the second set of random access occasions includes the one or more uplink symbols.

11. The apparatus of claim 1, wherein a network entity supports subband full-duplex operation and the UE supports half-duplex operation.

12. An apparatus for wireless communication at a network entity, comprising:
a processor;
memory coupled with the processor; and
instructions stored in the memory and executable by the processor to cause the apparatus to:
transmit a first indication of a set of random access occasions for connected mode operation for a user equipment (UE), the set of random access occasions comprising one or more subband full-duplex symbols and one or more uplink symbols, wherein a subband full-duplex symbol comprises one or more subbands allocated for uplink and one or more subbands allocated for downlink or flexible; and
receive a random access message via the set of random access occasions based at least in part on an operating mode of the UE being a connected operating mode.

13. The apparatus of claim 12, wherein the set of random access occasions comprises a first subset of random access occasions associated with the one or more subband full-duplex symbols within an uplink subband and a second subset of random access occasions associated with the one or more uplink symbols.

14. The apparatus of claim 12, wherein the instructions are further executable by the processor to cause the apparatus to:
transmit control information that schedules a downlink message via a periodic downlink occasion, a semi-persistent downlink occasion, or an aperiodic downlink occasion, wherein the scheduled downlink message at least partially overlaps the set of random access occasions and a set of corresponding gap symbols in time domain.

15. The apparatus of claim 12, wherein the instructions are further executable by the processor to cause the apparatus to:
transmit a second indication of a second set of random access occasions for initial access operation for the UE, the second set of random access occasions comprising one or more uplink symbols.

16. The apparatus of claim 15, wherein the second set of random access occasions for the initial access operation is associated with an initial bandwidth part of a primary cell and the set of random access occasions for the connected mode operation is associated with a first set of bandwidth parts of the primary cell or a second set of bandwidth parts of a second cell.

17. The apparatus of claim 15, wherein the instructions are further executable by the processor to cause the apparatus to:
perform an initial access procedure via the second set of random access occasions for the initial access operation based at least in part on the operating mode of the UE being an initial access operating mode.

18. The apparatus of claim 12, wherein the instructions are further executable by the processor to cause the apparatus to:
perform, via the set of random access occasions for the connected mode operation, a handover procedure or a beam failure recovery procedure based at least in part on the operating mode of the UE being the connected operating mode, wherein the random access message is received as part of the handover procedure or the beam failure recovery procedure.

19. The apparatus of claim 12, wherein the instructions are further executable by the processor to cause the apparatus to:
transmit a second indication of a second set of random access occasions for the connected mode operation and initial access operation for the UE, wherein the second set of random access occasions includes the one or more uplink symbols.

20. The apparatus of claim 12, wherein the network entity supports subband full-duplex operation and the UE supports half-duplex operation.

21. A method for wireless communication at a user equipment (UE), comprising:
receiving a first indication of a set of random access occasions for connected mode operation for the UE, the set of random access occasions comprising one or more subband full-duplex symbols and one or more uplink symbols, wherein a subband full-duplex symbol comprises one or more subbands allocated for uplink and one or more subbands allocated for downlink or flexible; and
transmitting a random access message via the set of random access occasions based at least in part on an operating mode of the UE being a connected operating mode.

22. The method of claim 21, wherein the set of random access occasions comprises a first subset of random access occasions associated with the one or more subband full-duplex symbols within an uplink subband and a second subset of random access occasions associated with the one or more uplink symbols.

23. The method of claim 21, further comprising:
receiving control information that schedules a downlink message via a periodic downlink occasion, a semi-persistent downlink occasion, or an aperiodic downlink occasion, wherein the scheduled downlink message at least partially overlaps the set of random access occasions and a set of corresponding gap symbols in time domain.

24. The method of claim 23, further comprising:
prioritizing reception of the downlink message via the set of random access occasions over transmission of the random access message via the set of random access occasions based at least in part on a prioritization rule.

25. The method of claim 23, further comprising:
prioritizing transmission of the random access message via the set of random access occasions over reception of the downlink message based at least in part on a prioritization rule.

26. A method for wireless communication at a network entity, comprising:
transmitting a first indication of a set of random access occasions for connected mode operation for a user equipment (UE), the set of random access occasions comprising one or more subband full-duplex symbols and one or more uplink symbols, wherein a subband full-duplex symbol comprises one or more subbands allocated for uplink and one or more subbands allocated for downlink or flexible; and
receiving a random access message via the set of random access occasions based at least in part on an operating mode of the UE being a connected operating mode.

27. The method of claim 26, wherein the set of random access occasions comprises a first subset of random access occasions associated with the one or more subband full-duplex symbols within an uplink subband and a second subset of random access occasions associated with the one or more uplink symbols.

28. The method of claim 26, further comprising:
transmitting control information that schedules a downlink message via a periodic downlink occasion, a semi-persistent downlink occasion, or an aperiodic downlink occasion, wherein the scheduled downlink message at least partially overlaps the set of random access occasions and a set of corresponding gap symbols in time domain.

29. The method of claim 26, further comprising:
transmitting a second indication of a second set of random access occasions for initial access operation for the UE, the second set of random access occasions comprising one or more uplink symbols.

30. The method of claim 29, wherein the second set of random access occasions for the initial access operation is associated with an initial bandwidth part of a primary cell and the set of random access occasions for the connected mode operation is associated with a first set of bandwidth parts of the primary cell or a second set of bandwidth parts of a second cell.
